(19) United States
(12) Patent Application Publication
(10) Pub. No.: US 2025/0379229 A1
(43) Pub. Date: Dec. 11, 2025

(54) ANODE FOR SECONDARY BATTERY AND SECONDARY BATTERY INCLUDING THE SAME

(71) Applicant: SK ON CO., LTD., Seoul (KR)

(72) Inventors: Sung Do KIM, Daejeon (KR); Jeong A KIM, Daejeon (KR); Yong Seok LEE, Daejeon (KR)

(21) Appl. No.: 19/228,754

(22) Filed: Jun. 5, 2025

(30) Foreign Application Priority Data
Jun. 5, 2024 (KR) 10-2024-0073782

(51) Int. Cl. H01M 4/587; H01M 4/133; H01M 4/36; H01M 4/62; H01M 10/052

(52) U.S. Cl. CPC H01M 4/587; H01M 4/133; H01M 4/366; H01M 4/625; H01M 10/052

(57) ABSTRACT

An anode for a secondary battery includes: an anode current collector, a first anode active material layer disposed on at least one surface of the anode current collector and including a first anode active material and a first binder, and a second anode active material layer disposed on the first anode active material layer and including a second anode active material, a second binder, and a conductive additive, wherein the conductive additive includes a conductive polymer and a water-soluble polymer having a weight average molecular weight of 10,000 g/mol to 100,000 g/mol.

### CROSS-REFERENCE TO RELATED APPLICATIONS

This application claims priority under 35 U.S.C. § 119 to Korean Patent Application No. 10-2024-0073782, filed on Jun. 5, 2024, the disclosure of which is incorporated herein by reference in its entirety.

### BACKGROUND OF THE INVENTION

### 1. Field of the Invention

The present disclosure relates to an anode for a secondary battery and a secondary battery including the same.

### 2. Description of the Related Art

A secondary battery is a battery that can be repeatedly charged and discharged. With the rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as an electric vehicle, a hybrid vehicle, etc., as their power sources.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design. In this regard, the lithium secondary battery has been actively developed and applied to various industrial fields.

For example, the lithium secondary battery may include a cathode and an anode. The electrodes such as the cathode and the anode may include an electrode active material capable of reversibly intercalating and deintercalating lithium ions, and current may be generated through a chemical reaction at the electrodes. A carbon-based material, a silicon-based material, or the like may be used as an anode active material.

During the charging/discharging process of the lithium secondary battery, the volume change of the anode active material layer may increase. When the volume of the anode active material layer expands, for example, the contact between a conductive material and the active material may be deteriorated, and the electrical conductivity of the anode active material layer may decrease.

### SUMMARY OF THE INVENTION

An object of the present disclosure is to provide an anode for a secondary battery having improved electrical properties and cycle life properties.

Another object of the present disclosure is to provide a secondary battery including the anode having improved electrical properties and cycle life properties.

An anode for a secondary battery according to embodiments of the present disclosure includes: an anode current collector; a first anode active material layer disposed on at least one surface of the anode current collector and including a first anode active material and a first binder; and a second anode active material layer disposed on the first anode active material layer and including a second anode active material, a second binder, and a conductive additive, wherein the conductive additive includes a conductive polymer and a water-soluble polymer having a weight average molecular weight of 10,000 g/mol to 100,000 g/mol.

In some embodiments, the first anode active material and the second anode active material may each independently include a silicon-based active material and a carbon-based active material.

In some embodiments, a content of the silicon-based active material included in the first anode active material may be 3% by weight to 10% by weight based on a total weight of the first anode active material layer, and a content of the silicon-based active material included in the second anode active material may be 10% by weight to 40% by weight based on a total weight of the second anode active material layer.

In some embodiments, a content of the carbon-based active material included in the first anode active material may be 90% by weight to 97% by weight based on the total weight of the first anode active material layer, a content of the carbon-based active material included in the second anode active material may be 60% by weight to 90% by weight based on the total weight of the second anode active material layer.

In some embodiments, the conductive polymer may include at least one selected from the group consisting of poly(3,4-ethylenedioxythiophene) (PEDOT), polyacetylene (PA), polypyrrole (PPy), polythiophene (PT), polyphenylene sulfide (PPS), poly(p-phenylene vinylene) (PPV), and polyaniline (PANI).

In some embodiments, the water-soluble polymer may be electrostatically bonded to the conductive polymer.

In some embodiments, the water-soluble polymer may include polyacrylic acid (PAA), polyvinyl alcohol (PVA) or a copolymer of polyacrylic acid and polyvinyl alcohol (PAA-PVA copolymer).

In some embodiments, a ratio of the content of the conductive polymer to the content of the water-soluble polymer may be 1 to 9 by weight.

In some embodiments, a content of the conductive additive included in the second anode active material layer may be 0.01% by weight to 2% by weight based on the total weight of the second anode active material layer.

In some embodiments, the second anode active material layer may further include a conductive material.

In some embodiments, the conductive material may include carbon nanotubes.

In some embodiments, a content of the conductive material may be 0.05% by weight to 2% by weight based on the total weight of the second anode active material layer.

In some embodiments, a content of the conductive additive in the total weight of the second anode active material layer may be lower than the content of the second binder.

A secondary battery according to embodiments of the present disclosure includes: the above-described anode for a secondary battery; and a cathode disposed to face the anode.

The anode for a secondary battery according to embodiments of the present disclosure may include a first anode active material layer disposed on an anode current collector and a second anode active material layer disposed on the first anode active material layer. The second anode active material layer may include a conductive additive including a conductive polymer and a water-soluble polymer.

The conductive polymer may provide a migration pathway for electrons. The dispersibility of the conductive additive may be improved by the water-soluble polymer. Therefore, a migration pathway for electrons between the anode active material and the conductive material may be additionally provided or supplemented.

Accordingly, the resistance of the anode may be reduced and the fast-charging properties of the secondary battery may be improved.

The secondary battery according to the embodiments of the present disclosure may be widely applied in green technology fields, such as electric vehicles, battery charging stations, as well as solar power generation, wind power generation, and the like, which use the batteries. In addition, the secondary battery according to the embodiments of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an anode for a secondary battery according to exemplary embodiments;

FIGS. 2 and 3 are schematic plan and cross-sectional views illustrating a secondary battery according to exemplary embodiments, respectively; and

FIG. 4 is a schematic graph illustrating the fast-charging properties of secondary batteries according to Examples 1 and 2, and Comparative Examples 2 and 3.

### DETAILED DESCRIPTION OF THE INVENTION

The embodiments of the present disclosure provide an anode for a secondary battery including a conductive additive.

The embodiments of the present disclosure provide a secondary battery including the anode for a secondary battery.

The terms “upper portion,” “lower portion,” “upper surface,” “lower surface,” etc. as used herein are intended to describe the relative positional relationship of the respective components and do not mean an absolute upper-lower relationship.

As used herein, the terms “first” and “second” do not limit the number or order of subjects modified by the “first” and the “second,” but are used to distinguish the modified subjects which are different from each other.

Hereinafter, the embodiments of the present invention will be described in detail with reference to the accompanying drawings. However, since the drawings attached to the present disclosure are only given for illustrating one of several preferred embodiments of the present invention to easily understand the technical spirit of the present invention with the above-described invention, it should not be construed as limited to such a description illustrated in the drawings.

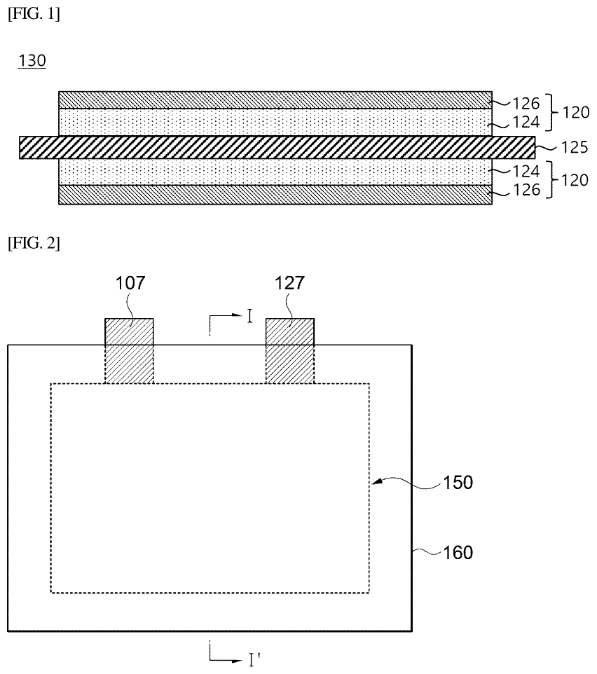

FIG. 1 is a schematic cross-sectional view illustrating an anode for a secondary battery (hereinafter, also abbreviated as the anode) according to exemplary embodiments.

Referring to FIG. 1, an anode 130 includes an anode current collector 125 and an anode active material layer 120 disposed on at least one surface of the anode current collector 125.

The anode active material layer 120 may have a multi-layer structure (e.g., a double-layer structure) in which a plurality of layers are stacked. Accordingly, the composition, physical properties, etc. of each layer may be adjusted so that the anode active material layer 120 may be designed to have high electrode adhesion strength, as well as low-resistance properties, improved capacity and conductivity.

According to exemplary embodiments, the anode active material layer 120 may include a first anode active material layer 124 and a second anode active material layer 126. The first anode active material layer 124 may be disposed on the anode current collector 125. The second anode active material layer 126 may be disposed on the first anode active material layer 124. For example, the second anode active material layer 126 may be spaced apart from the anode current collector 125 with the first anode active material layer 124 therebetween.

In some embodiments, the first anode active material layer 124 may be in direct contact with at least one surface of the anode current collector 125. In some embodiments, the second anode active material layer 126 may be in direct contact with one surface of the first anode active material layer 124.

In some embodiments, the anode active material layer 120 may be formed on both surfaces (e.g., upper and lower surfaces) of the anode current collector 125.

In some embodiments, the anode current collector 125 may include gold, stainless steel, nickel, aluminum, titanium, copper, or an alloy thereof. For example, the anode current collector 125 may include copper or a copper alloy.

The first anode active material layer 124 may include a first anode active material and a first binder. For example, a first anode slurry including the first anode active material and the first binder may be applied to the anode current collector 125 to form the first anode active material layer 124.

The second anode active material layer 126 may include a second anode active material and a second binder. For example, a second anode slurry including the second anode active material and the second binder may be applied to the first anode active material layer 124 to form the second anode active material layer 126.

The first anode active material and the second anode active material may each independently include a silicon-based active material or a carbon-based active material.

The silicon-based active material may include, for example, silicon (Si), silicon oxide (SiOₓ, 0≤x≤2), silicon oxide (SiOₓ, 0≤x≤2) containing a lithium compound, a silicon-metal alloy, or a silicon-carbon composite (Si—C). These may be used alone or in combination of two or more thereof.

The SiOₓ containing a lithium compound may be SiOₓ including lithium silicate. The lithium silicate may be present in at least a portion of the SiOₓ (0≤x≤2) particles, and for example, may be present inside and/or on the surface of the SiOₓ (0≤x≤2) particles. The lithium silicate may include LizSiO₃, LizSi₂O₅, Li₄SiO₄, Li₄Si₃O₈, etc.

The carbon-based active material may include, for example, soft carbon, hard carbon, natural graphite, artificial graphite, or a mixture thereof. These may be used alone or in combination of two or more thereof.

In some embodiments, the carbon-based active material may include a graphite-based material such as natural graphite or artificial graphite. By including a graphite-based material as the carbon-based active material, the capacity reduction of the anode active material may be suppressed while improving the cycle life properties of the anode 130.

In one embodiment, the carbon-based active material may include artificial graphite. Artificial graphite may have relatively high ion conductivity, improved stability and heat resistance compared to natural graphite. Therefore, by including artificial graphite as the carbon-based active material, the cycle life properties and stability of the anode 130 may be further improved.

In one embodiment, the first binder and the second binder may include an aqueous binder.

For example, the aqueous binder may include styrene-butadiene rubber (SBR), carboxymethyl cellulose (CMC), polyacrylic acid (PAA), polyvinyl alcohol (PVA), polyacrylonitrile, polyacrylamide, or a copolymer thereof. These may be included alone or in combination of two or more thereof.

According to exemplary embodiments, the first anode active material and the second anode active material may each independently include a silicon-based active material and a carbon-based active material. For example, the first anode active material and the second anode active material may each independently include a mixture of a silicon-based active material and a carbon-based active material.

The energy density and capacity properties of the secondary battery may be improved by the silicon-based active material. In addition, the volume change caused by the silicon-based active material may be suppressed by the carbon-based active material, thereby further improving the cycle life properties of the secondary battery.

In exemplary embodiments, the content of the carbon-based active material in the total weight of the anode active material may be greater than the content of the silicon-based active material. Accordingly, the energy density and capacity of the anode 130 may be enhanced.

In some embodiments, the content of the silicon-based active material in the total weight of the first anode active material may be less than the content of the silicon-based active material in the total weight of the second anode active material. As used herein, the term “content of b in A” may mean the content (wt %) of b included in A based on the total weight of A.

When a high content of silicon-based active material is included in an upper region of the anode active material layer 120, the energy density and capacity properties of the anode active material layer 120 may be improved.

In exemplary embodiments, a content of the silicon-based active material included in the first anode active material may be 3 wt % to 10 wt % based on the total weight of the first anode active material layer 124, for example, 5 wt % to 7 wt %. Within the above range, detachment, peeling, or cracking of the anode active material layer 120 due to volume expansion of the first anode active material layer 124 may be prevented.

In exemplary embodiments, a content of the silicon-based active material included in the second anode active material may be 10 wt % to 40 wt % based on the total weight of the second anode active material layer 126, for example, 25 wt % to 30 wt %. Within the above range, high capacity and high energy density may be provided by the second anode active material layer 126.

In some embodiments, the content of the carbon-based active material in the total weight of the first anode active material may be greater than the content of the carbon-based active material in the total weight of the second anode active material.

As a high content of carbon-based active material is included in a lower region of the anode active material layer 120 adjacent to the anode current collector 125, the electrical conductivity of the anode active material may be improved and the internal resistance of the secondary battery may be reduced.

In exemplary embodiments, a content of the carbon-based active material included in the first anode active material may be 90 wt % to 97 wt % based on the total weight of the first anode active material layer 124, for example, 93 wt % to 95 wt %. Within the above range, the resistance of the anode active material layer 120 may be reduced, while the cycle life properties and structural stability may be further improved.

In exemplary embodiments, a content of the carbon-based active material included in the second anode active material may be 60 wt % to 90 wt % based on the total weight of the second anode active material layer 126, for example, 70 wt % to 75 wt %. Within the above range, the second anode active material layer 126 may include a relatively high content of silicon-based active material, while the fast-charging properties and stability may be improved by the carbon-based active material.

In embodiments according to the present disclosure, the second anode active material layer 126 may include a conductive additive. The conductive additive may include a conductive polymer and a water-soluble polymer.

The conductive polymer may refer to a polymer having electrical conductivity. The conductive polymer may provide a migration pathway for electrons.

As the conductive additive is included in the second anode active material layer 126, the electrical conductivity and fast-charging properties of the anode 130 may be further improved. For example, the second anode active material layer 126 may be spaced farther from the anode current collector 125 and may have a relatively high content of a silicon-based active material with low electrical conductivity, thereby resulting in a lower overall electrical conductivity.

According to exemplary embodiments, by including the conductive additive in the second anode active material layer 126, the migration pathway for electrons within the second anode active material layer 126 may be supplemented, and a conductive network may be formed. As a result, the fast-charging properties and cycle life properties of the secondary battery may be further improved.

According to exemplary embodiments, the conductive polymer may include poly(3,4-ethylenedioxythiophene) (PEDOT), polyacetylene (PA), polypyrrole (PPy), polythiophene (PT), polyphenylene sulfide (PPS), poly(p-phenylene vinylene) (PPV), or polyaniline (PANI). These may be used alone or in combination of two or more, and for example, poly(3,4-ethylenedioxythiophene) (PEDOT) may be used.

According to exemplary embodiments, the conductive polymer may provide the migration pathway for electrons between the anode active material and the conductive material described below, thereby reducing the resistance of the anode 130. Accordingly, stable electrical conductivity may be implemented in the anode 130, thereby improving the cycle life properties and fast charging properties of the anode 130.

In exemplary embodiments, the water-soluble polymer may help to disperse the conductive polymer in a solvent or an anode slurry.

In exemplary embodiments, the water-soluble polymer may be electrostatically bonded to the conductive polymer. For example, the conductive additive may be formed by electrostatically bonding between the water-soluble polymer and the conductive polymer.

The water-soluble polymer may be bonded to the conductive polymer to improve the dispersibility of the conductive polymer in a solvent or an anode slurry. Accordingly, the conductive additive may be uniformly dispersed in the second anode active material layer 126, thereby providing a uniform migration pathway for electrons.

The water-soluble polymer may have a weight average molecular weight (Mw) of 10,000 g/mol to 100,000 g/mol. Within the above range, the bonding between the water-soluble polymer and the conductive polymer may be further promoted, and the dispersibility of the conductive additive may be further improved.

For example, if the weight average molecular weight (Mw) of the water-soluble polymer exceeds 100,000 g/mol, the interaction between the water-soluble polymer and the conductive polymer may increase, thereby deteriorating the dispersibility of the conductive additive. For example, if the weight average molecular weight (Mw) of the water-soluble polymer is less than 10,000 g/mol, the bonding between the water-soluble polymer and the conductive polymer may decrease, thereby deteriorating the dispersibility of the conductive additive.

In some embodiments, the water-soluble polymer may have a weight average molecular weight (Mw) of 15,000 g/mol to 90,000 g/mol, 25,000 g/mol to 80,000 g/mol, 30,000 g/mol to 70,000 g/mol, or 35,000 g/mol to 65,000 g/mol.

When the molecular weight of the water-soluble polymer falls within the above range, the electrical conductivity of the conductive additive may be further improved. For example, the bonding between the conductive polymer and the water-soluble polymer may be enhanced, and the dispersibility of the conductive additive may be further improved.

According to some embodiments, the conductive additive may have an electrical conductivity of 4×10⁻³ S/cm to 10×10⁻³ S/cm. For example, the electrical conductivity may range from 4.5×10⁻³ S/cm to 7×10⁻³ S/cm, or for example, from 5×10⁻³ S/cm to 6×10⁻³ S/cm.

The conductive additive may be included in the second anode active material layer 126, thereby providing a migration pathway for electrons within the anode active material layer 120.

As the electrical conductivity of the conductive additive falls within the above range, the migration pathway for electrons within the anode active material layer 120 may be further supplemented. Accordingly, the resistance of the anode 130 may be reduced, thereby further improving the fast-charging properties and cycle life properties of the secondary battery.

In some embodiments, the electrical conductivity of the conductive additive may be measured using a four-point-probe method. For example, at 25° C., four probes of a sourcemeter may be arranged in a row at intervals of 1 mm and attached to a sample to measure the electrical conductivity.

In exemplary embodiments, the water-soluble polymer may help to disperse the conductive additive in a hydrophilic solvent such as water.

The water-soluble polymer may include, for example, polyacrylic acid (PAA), polyvinyl alcohol (PVA), or a copolymer of polyacrylic acid and polyvinyl alcohol (PAA-PVA copolymer). By including the copolymer of polyacrylic acid and polyvinyl alcohol (PAA-PVA copolymer), the mechanical properties and adhesion strength of the water-soluble polymer may be improved, thereby buffering or accommodating the volume change of the silicon-based active material.

In some embodiments, the water-soluble polymer may include the same material as the second binder. Accordingly, the bonding strength between the second binder and the conductive additive in the anode slurry may be further improved.

According to exemplary embodiments, the content of the water-soluble polymer in the total weight of the conductive additive may be less than or equal to the content of the conductive polymer. For example, the content of the water-soluble polymer may be less than the content of the conductive polymer. As the content of the conductive polymer is relatively increased, the resistance of the anode 130 may be reduced and the cycle life properties may be improved.

According to exemplary embodiments, a ratio of the content of the conductive polymer to the content of the water-soluble polymer may be 1 to 9 by weight. For example, if the ratio of the content exceeds 9 by weight, the content of the water-soluble polymer may become too low, thereby reducing the bonding strength between the binder and the conductive additive in the anode slurry. For example, if the ratio of the content is less than 1 by weight, the migration pathway for electrons provided by the conductive polymer may not be sufficiently ensured.

In one embodiment, the ratio of the content of the conductive polymer to the content of the water-soluble polymer may be 1 to 5, greater than 1 and 5 or less, 2 to 5, or 2 to 4 by weight. Within the above range, the dispersibility of the conductive polymer may be improved, thereby forming a more uniform conductive network, as well as further reducing the internal resistance of the anode 130.

In one embodiment, the content of the conductive additive included in the second anode active material layer 126 may be 0.01 wt % to 2 wt % based on the total weight of the second anode active material layer 126.

If the content of the conductive additive exceeds 2 wt % based on the total weight of the second anode active material layer 126, the conductive additive and the second binder may be aggregated. Accordingly, fine particles may be formed in the anode slurry, thereby degrading the cycle life properties of the secondary battery. If the conductive additive is included in an amount of less than 0.01 wt % based on the total weight of the second anode active material layer 126, the electrical conductivity of the anode 130 may be reduced.

For example, the content of the conductive additive may be 0.01 wt % to 0.2 wt %, or 0.01 wt % to 0.15 wt % based on the total weight of the second anode active material layer 126. In exemplary embodiments, the first anode active material layer 124 may further include the conductive additive. The conductive additive contained in the first anode active material layer 124 may include a conductive polymer and a water-soluble polymer. For example, the conductive additive contained in the first anode active material layer 124 may include a compound that is substantially the same as the conductive additive contained in the second anode active material layer 126.

In one embodiment, the water-soluble polymer contained in the first anode active material layer 124 may include a material that is substantially the same as the first binder.

In exemplary embodiments, as the conductive additive is independently further included in both the first anode active material layer 124 and the second anode active material layer 126, the fast-charging properties and cycle life properties of the secondary battery may be further improved.

In exemplary embodiments, the second anode active material layer 126 may further include a conductive material.

In some embodiments, the first anode active material layer 124 may further include a first conductive material. The conductive material included in the second anode active material layer 126 may refer to a second conductive material.

The first conductive material and the second conductive material may each independently include carbon nanotubes (CNTs). For example, the carbon nanotubes (CNTs) may include single-walled carbon nanotubes (SWCNTs) and/or multi-walled carbon nanotubes (MWCNTs). Accordingly, the resistance of the anode 130 may be reduced, and the initial efficiency and output properties of the secondary battery may be further improved.

In some embodiments, the first conductive material and/or the second conductive material may include single-walled carbon nanotubes (SWCNTs). The single-walled carbon nanotubes (SWCNTs) may have improved thermal stability and electrical conductivity compared to multi-walled carbon nanotubes (MWCNTs). Accordingly, even if the anode active material layer 120 includes a silicon-based active material, the low-resistance properties and stability of the anode active material layer 120 may be enhanced.

In some embodiments, the content of the second conductive material may be 0.05 wt % to 2 wt % based on the total weight of the second anode active material layer 126. For example, if the content of the second conductive material exceeds 2 wt % based on the total weight of the second anode active material layer 126, the content of the anode active material may become too low, thereby reducing the capacity of the anode 130. For example, if the content of the second conductive material is less than 0.05 wt %, the electrical conductivity of the anode 130 may be reduced.

In some embodiments, the content of the second conductive material may be greater than 0.05 wt % and 0.3 wt % or less, or 0.1 wt % and 0.2 wt % based on the total weight of the second anode active material layer 126. Within the above range, the high-capacity properties and electrical properties of the anode 130 may be further improved.

For example, when the content of the second conductive material is increased to secure the electrical conductivity of the anode 130, the capacity of the anode 130 may decrease, thereby degrading the performance of the secondary battery.

According to exemplary embodiments of the present disclosure, by including the conductive additive in the second anode active material layer 126, the capacity properties and electrical properties of the anode 130 may be simultaneously enhanced.

In one embodiment, the content of the conductive additive in the total weight of the second anode active material layer 126 may be lower than the content of the second binder. For example, if the content of the conductive additive is higher than the content of the second binder, the content of the second binder may decrease, thereby reducing the binding force in the anode slurry and degrading the cycle life properties of the battery.

The secondary battery according to embodiments of the present disclosure includes the above-described anode 130.

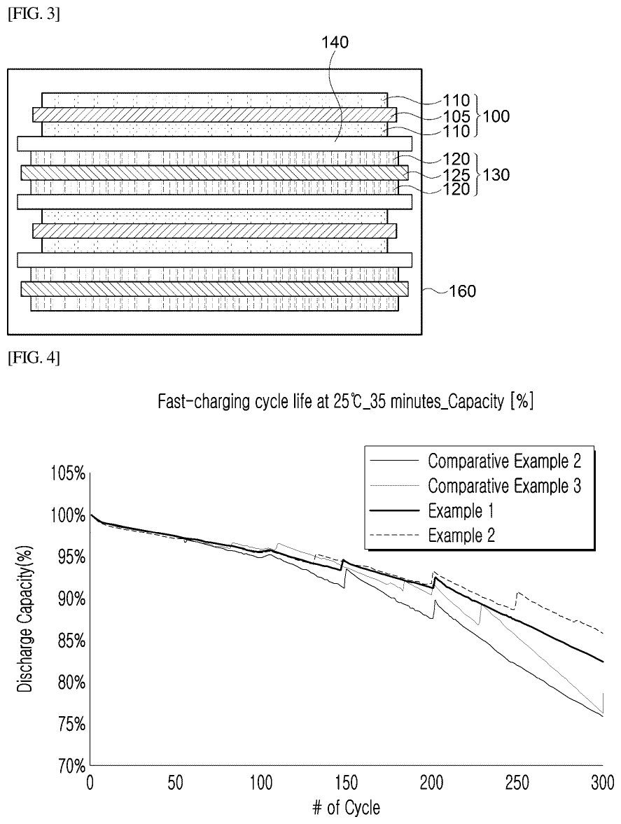

FIGS. 2 and 3 are schematic plan and cross-sectional views, respectively, of the secondary battery according to exemplary embodiments.

Referring to FIGS. 2 and 3, the secondary battery may include the anode 130 and the cathode 100 disposed to face the anode 130.

The cathode 100 may include a cathode current collector 105 and a cathode active material layer 110 formed on at least one surface of the cathode current collector 105. In one embodiment, the cathode active material layer 110 may be formed on both surfaces (e.g., upper and lower surfaces) of the cathode current collector 105.

The cathode current collector 105 may include stainless steel, nickel, aluminum, titanium, or an alloy thereof. The cathode current collector 105 may include aluminum or stainless steel having a surface treated with carbon, nickel, titanium, or silver.

Examples of cathode active materials may include lithium nickel-based oxides, lithium cobalt-based oxides such as LiCoO₂, lithium manganese-based oxides such as LiMnO₃, LiMn₂O₃, and LiMnO₂, lithium copper oxides such as Li₂CuO₂, vanadium oxides such as LiV₃O₈, LiFe₃O₄, V₂O₅, and Cu₂VO₇, lithium iron phosphate oxides such as LiFePO₄, and lithium-sulfur compounds such as Li₂S, etc.

In some embodiments, the cathode active material may include a compound represented by Formula 1 below.

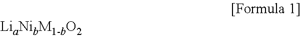

In Formula 1, a and b may satisfy 0.95≤a≤1.08, b≥0.5, and M may be at least one element selected from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In one embodiment, the cathode active material includes nickel (Ni), and may further include at least one of cobalt (Co) or manganese (Mn). For example, nickel-cobalt-manganese (NCM)-based lithium oxide may be used as the cathode active material.

For example, nickel (Ni) may be provided as a metal associated with the capacity of the lithium secondary battery. The higher the content of nickel, the greater the improvement in capacity and output of the lithium secondary battery. However, if the content of nickel increases excessively, the cycle life of the lithium secondary battery may be reduced, and it may be disadvantageous in terms of mechanical and electrical stabilities.

In one embodiment, the conductivity or resistance of the lithium secondary battery may be improved by cobalt (Co), and the mechanical and electrical stabilities of the lithium secondary battery may be enhanced by manganese (Mn).

The chemical structure represented by Formula 1 shows a bonding relationship between elements included in the lattice structure or crystal structure of the cathode active material, and does not exclude other additional elements. For example, M may be provided as a main active element of the cathode active material. Here, it should be understood that Formula 1 is provided to express the bonding relationship between the main active elements, and is a formula encompassing the introduction and substitution of the additional elements.

In one embodiment, the cathode active material may further include auxiliary elements which are added to the main active elements, in order to enhance chemical stability thereof or the crystal structure. The auxiliary element may be incorporated into the crystal structure together to form a bond, and it should be understood that this case is also included within the chemical structure represented by Formula 1.

The cathode binder may include polyvinylidene fluoride (PVDF), polyvinylidene fluoride-co-hexafluoropropylene, polyacrylonitrile, polymethylmethacrylate, acrylonitrile butadiene rubber (NBR), polybutadiene rubber (BR), styrene-butadiene rubber (SBR) and the like. In one embodiment, a PVDF-based binder may be used as the cathode binder.

The cathode conductive material may include a carbon-based conductive material such as graphite, carbon black, graphene, carbon nanotubes, carbon fibers, and/or a metal-based conductive material including tin, tin oxide, titanium oxide, or a perovskite material such as LaSrCoO₃, and LaSrMnO₃.

The separation membrane 140 may be interposed between the cathode 100 and the anode 130. The separation membrane 140 may include a porous polymer film made of a polyolefin polymer such as ethylene homopolymer, propylene homopolymer, ethylene/butene copolymer, ethylene/hexene copolymer, ethylene/methacrylate copolymer. The separation membrane 140 may include a nonwoven fabric made of glass fibers having a high melting point, polyethylene terephthalate fibers, etc.

According to exemplary embodiments, the cathode 100, the anode 130 and the separation membrane 140 may be repeatedly disposed to form an electrode assembly 150. In some embodiments, the electrode assembly 150 may have a jelly roll shape formed by winding, stacking, z-folding, or stack-folding the separation membrane 140.

The electrode assembly 150 may be housed in a case 160 to define a secondary battery. According to exemplary embodiments, the electrode assembly 150 may be housed in the case 160 together with an electrolyte. A non-aqueous electrolyte may be used as the electrolyte.

The non-aqueous electrolyte may include a lithium salt of an electrolyte and an organic solvent. The lithium salt is represented by, for example, Li⁺X⁻, and as an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻ and (CF₃CF₂SO₂)₂N⁻, etc. may be exemplified.

As the organic solvent, for example, propylene carbonate (PC), ethylene carbonate (EC), diethyl carbonate (DEC), dimethyl carbonate (DMC), ethyl methyl carbonate (EMC), methyl propyl carbonate, dipropyl carbonate, dimethyl sulfoxide, acetonitrile, dimethoxyethane, diethoxyethane, vinylene carbonate, sulfolane, γ-butyrolactone, propylene sulfite, tetrahydrofuran, and the like may be used. These compounds may be used alone or in combination of two or more thereof.

As illustrated in FIG. 2, electrode tabs (a cathode tab and an anode tab) protrude from the cathode current collector 105 and the anode current collector 125, respectively, which belong to each electrode cell, and may extend to one side of the outer case 160. The electrode tabs may be fused together with the one side of the outer case 160 to form electrode leads (a cathode lead 107 and an anode lead 127) that extend or are exposed to the outside of the outer case 160.

The lithium secondary battery may be manufactured, for example, in a cylindrical shape using a can, a prismatic shape, a pouch shape or a coin shape.

Hereinafter, embodiments of the present invention will be further described with reference to specific experimental examples. However, the following examples and comparative examples included in the experimental examples are only given for illustrating the present invention and those skilled in the art will obviously understand that various alterations and modifications are possible within the scope and spirit of the present invention. Such alterations and modifications are duly included in the appended claims.

### Preparative Example

### Preparative Example 1

Ethylenedioxythiophene (EDOT), polyacrylic acid (PAA) (Sigma-Aldrich), ammonium persulfate (APS), and iron sulfate (FS) were mixed to prepare a reaction mixture. The reaction mixture was mechanically stirred for 48 hours and then washed to prepare a conductive additive. The weight ratio of EDOT to PAA based on the total weight of the reaction mixture was 7:3.

### Preparative Examples 2 to 8

Conductive additives were prepared in the same manner as in Preparative Example 1, except that the weight average molecular weight of the water-soluble polymer was changed as described in Table 1.

### Experimental Example 1: Evaluation of Electrical Conductivity

The electrical conductivity of the conductive additives according to the preparative examples was measured. Specifically, the measurement of the electrical conductivity was conducted at 25° C. using the four-point-probe method. Specifically, four probes were arranged in a row at intervals of 1 mm and attached to the sample, and the electrical conductivity was measured using an electrical measuring device (sourcemeter).

The weight average molecular weight of each conductive additive and the electrical conductivity according to the preparative examples are shown in Table 1 below.

TABLE 1

| | Conductive additive | |
|---|---|---|
| | Weight average molecular | Electrical |
| | weight of water-soluble | conductivity |
| | polymer (g/mol) | (×10⁻³ S/cm) |
| Preparative Example 1 | 50,000 | 5.9 |
| Preparative Example 2 | 10,000 | 4.72 |
| Preparative Example 3 | 20,000 | 5.64 |
| Preparative Example 4 | 100,000 | 4.46 |
| Preparative Example 5 | 5,000 | 3.62 |
| Preparative Example 6 | 300,000 | 1.07 |

Referring to Table 1 above, in the case of Preparative Examples 1 to 4, the molecular weight of the water-soluble polymer fell within the range of 10,000 g/mol to 100,000 g/mol, thereby further improving the electrical conductivity of the conductive additive.

In the case of Preparative Examples 5 and 6, the molecular weight of the water-soluble polymer was outside the range of 10,000 g/mol to 100,000 g/mol, and thus the electrical conductivity decreased further.

### EXAMPLES AND COMPARATIVE EXAMPLES

### Example 1

### (1) Preparation of Anode

A first anode slurry was prepared including 94.2 wt % of graphite and 3 wt % of silicon oxide (SiOₓ, 0≤x≤2) as a first anode active material, 0.1 wt % of single-walled carbon nanotubes (SWCNTs) as a conductive material, 1.5 wt % of styrene-butadiene rubber (SBR) as a binder, and 1.2 wt % of carboxymethyl cellulose (CMC) as a thickener. The first anode slurry was applied to a copper substrate, dried, and then pressed to prepare a first anode active material layer. A second anode slurry was prepared by including 62.1 wt % of graphite and 35 wt % of silicon oxide (SiOₓ, 0≤x≤2) as a second anode active material, 0.1 wt % of single-walled carbon nanotubes (SWCNTs) as a conductive material, 1.5 wt % of styrene-butadiene rubber (SBR) as a binder, 1.2 wt % of carboxymethyl cellulose (CMC) as a thickener, and 0.1 wt % of a conductive additive according to Preparative Example 1. The second anode slurry was applied to the first anode active material layer, dried, and then pressed to prepare a second anode active material layer.

### (2) Manufacture of a Secondary Battery

A cathode slurry was prepared by mixing Nickel-Cobalt-Manganese (NCM) as a cathode active material, carbon nanotubes (CNTs) as a conductive material, and polyvinylidenefluoride (PVDF) as a binder in a mass ratio of 98:1:1. Thereafter, the cathode slurry was applied to an aluminum current collector, pressed, and then dried to form a cathode.

The cathode and the anode prepared as described above were respectively notched into a predetermined size and stacked with a separation membrane (polyethylene, thickness: 13 μm) interposed between the cathode and the anode.

An electrolyte was prepared by adding 5 wt % of fluorinated ethylene carbonate (FEC), 0.5 wt % of propane sulfone (PS), and 0.5 wt % of ethylene sulfate (ESA) to a mixed solvent of EC/EMC/DEC (25/45/30, volume ratio) in which 1 M LiPF₆ had been dissolved.

A secondary battery was manufactured by placing an assembly of cathode/separation membrane/anode into a pouch, and injecting an electrolyte into the pouch, followed by impregnation for 12 hours or more.

### Example 2

A first anode slurry was prepared including 93.2 wt % of graphite and 3 wt % of silicon oxide (SiOₓ, 0≤x≤2) as a first anode active material, 0.1 wt % of single-walled carbon nanotubes (SWCNTs) as a conductive material, 1.5 wt % of styrene-butadiene rubber (SBR) as a binder, 1.2 wt % of carboxymethyl cellulose (CMC) as a thickener, and 0.1 wt % of the conductive additive according to Preparative Example 1. The first anode slurry was applied to a copper substrate, dried, and then pressed to prepare a first anode active material layer.

The preparation of the second anode active material layer, as well as the fabrication of the anode, cathode, and secondary battery, were performed in the same manner as in Example 1.

### Comparative Example 1

An anode slurry was prepared including 93.2 wt % of graphite and 3 wt % of silicon oxide (SiOₓ, 0≤x≤2) as an anode active material, 0.1 wt % of single-walled carbon nanotubes (SWCNTs) as a conductive material, 1.5 wt % of styrene-butadiene rubber (SBR) as a binder, 1.2 wt % of carboxymethyl cellulose (CMC) as a thickener, and 0.1 wt % of the conductive additive according to Preparative Example 1. The anode slurry was applied to a copper single-layer substrate, dried, and then pressed to prepare a single-layer anode.

The preparation of the cathode and the secondary battery was performed in the same manner as the preparation of the cathode and the secondary battery in Example 1.

### Comparative Example 2

A first anode slurry was prepared including 94.05 wt % of graphite and 3 wt % of silicon oxide (SiOₓ, 0≤x≤2) as a first anode active material, 0.25 wt % of single-walled carbon nanotubes (SWCNTs) as a conductive material, 1.5 wt % of styrene-butadiene rubber (SBR) as a binder, and 1.2 wt % of carboxymethyl cellulose (CMC) as a thickener. The first anode slurry was applied to a copper substrate, dried, and then pressed to prepare a first anode active material layer.

A second anode slurry was prepared including 63.1 wt % of graphite, and 35 wt % of silicon oxide (SiOₓ, 0≤x≤2) as a second anode active material, 0.1 wt % of single-walled carbon nanotubes (SWCNTs) as a conductive material, 1.5 wt % of styrene-butadiene rubber (SBR) as a binder, and 1.2 wt % of carboxymethyl cellulose (CMC) as a thickener. The second anode slurry was applied to the first anode active material layer, dried, and then pressed to prepare a second anode active material layer.

The preparation of the cathode and the secondary battery was performed in the same manner as the preparation of the cathode and the secondary battery in Example 1.

### Comparative Example 3

A first anode slurry was prepared including 93.2 wt % of graphite and 3 wt % of silicon oxide (SiOₓ, 0≤x≤2) as a first anode active material, 0.1 wt % of single-walled carbon nanotubes (SWCNTs) as a conductive material, 1.5 wt % of styrene-butadiene rubber (SBR) as a binder, 1.2 wt % of carboxymethyl cellulose (CMC) as a thickener, and 0.1 wt % of the conductive additive according to Preparative Example 1. The first anode slurry was applied to a copper substrate, dried, and then pressed to prepare a first anode active material layer.

The preparation of the second anode active material layer, the anode, the cathode, and the secondary battery was performed in the same manner as in Comparative Example 2.

### Experimental Example 2: Evaluation of Internal Resistance (DC-IR)

The secondary batteries according to the examples and comparative examples were charged (CC/CV, rate of 0.33 C) to a voltage corresponding to 100% SOC in a chamber maintained at 25° C., and then discharged (CC, 0.33 C) to a voltage corresponding to 50% SOC.

At the 50% SOC point, discharge was performed at a C-rate of 1 C for 10 seconds. In this case, the terminal voltage points were plotted to construct a linear equation, and the slope of the resulting line was adopted as the DC-IR for evaluating the internal resistance.

### Experimental Example 3: Measurement of Discharge Capacity, Average Voltage, and Utilization Capacity, and Evaluation of Fast-Charging Properties

The secondary batteries according to the examples and comparative examples were charged in a chamber maintained at 25° C. at C-rates of 3.25 C, 3 C, 2.75 C, 2.5 C, 2.25 C, 2.0 C, 1.75 C, 1.5 C, 1.25 C, 1.0 C, 0.75 C, and 0.5 C in a stepwise charging manner so as to reach a depth of discharge (DOD) of 72% within 35 minutes, and then discharged at a rate of 1/3 C. The charging and discharging process was defined as one cycle, and was repeated for 300 cycles.

The discharge capacity at each cycle was measured, and the results are shown in FIG. 4.

In the first cycle, the discharge capacity (Ah), average voltage (V), and utilization capacity (mAh/g) at 1/3 C were measured.

In addition, the ratio (%) of the discharge capacity at the 300th cycle to the discharge capacity at the first cycle was measured as the capacity retention rate, thereby evaluating the fast-charging properties of the secondary batteries.

The results are shown in Table 2 below.

TABLE 2

| | Dis- | | Utiliza- | | |
|---|---|---|---|---|---|
| | charge | Average | tion | Internal | Fast-charging |
| | capacity | voltage | capacity | resistance | properties (%, |
| | (Ah) | (V) | (mAh/g) | (mΩ) | 300th cycle) |
| Example 1 | 93.1 | 3.5 | 187.4 | 1.131 | 82.5 |
| Example 2 | 93.2 | 3.509 | 188.6 | 1.126 | 85.8 |
| Comparative | 92.9 | 3.503 | 186.7 | 1.2 | 79.6 |
| Example 1 | | | | | |
| Comparative | 92.2 | 3.503 | 185.5 | 1.144 | 75.8 |
| Example 2 | | | | | |
| Comparative | 92.5 | 3.502 | 185.9 | 1.14 | 76.2 |
| Example 3 | | | | | |

Referring to Table 2 and FIG. 4, the secondary batteries according to the examples exhibited an improved capacity retention rate at the 300th cycle by including a conductive additive in the second anode active material layer (hereinafter, the upper layer).

Referring to FIG. 4, in the case of the examples, the discharge capacity retention rate at each cycle relative to the first cycle was improved. In the case of the comparative examples, the discharge capacity continuously decreased as the cycles were repeated.

Referring to Table 2, in the case of Comparative Example 1, since the conductive additive was included in the single-layer anode, the fast-charging properties were deteriorated compared to Example 1.

In the case of Comparative Example 2, since the conductive additive was not included, the internal resistance increased compared to the examples including the conductive additive. Therefore, the fast-charging properties of the secondary battery were deteriorated.

In the case of Comparative Example 3, since the conductive additive was included in a lower layer, the internal resistance slightly decreased compared to Comparative Example 2, and the fast-charging properties were slightly improved. However, the extent of improvement in internal resistance and fast-charging properties was not significant compared to the case in which the conductive additive was included in the upper layer and the case in which the conductive additive was included in both the upper and lower layers.

What is claimed is:

1. An anode for a secondary battery comprising:
an anode current collector;
a first anode active material layer disposed on at least one surface of the anode current collector and comprising a first anode active material and a first binder; and
a second anode active material layer disposed on the first anode active material layer and comprising a second anode active material, a second binder, and a conductive additive,
wherein the conductive additive comprises a conductive polymer and a water-soluble polymer having a weight average molecular weight of 10,000 g/mol to 100,000 g/mol.

2. The anode for a lithium secondary battery according to claim 1, wherein the first anode active material and the second anode active material each independently comprise a silicon-based active material and a carbon-based active material.

3. The anode for a lithium secondary battery according to claim 2, wherein a content of the silicon-based active material included in the first anode active material is 3% by weight to 10% by weight based on a total weight of the first anode active material layer, and
a content of the silicon-based active material included in the second anode active material is 10% by weight to 40% by weight based on a total weight of the second anode active material layer.

4. The anode for a lithium secondary battery according to claim 2, wherein a content of the carbon-based active material included in the first anode active material is 90% by weight to 97% by weight based on the total weight of the first anode active material layer, and
a content of the carbon-based active material included in the second anode active material is 60% by weight to 90% by weight based on the total weight of the second anode active material layer.

5. The anode for a lithium secondary battery according to claim 1, wherein the conductive polymer comprises at least one selected from the group consisting of poly(3,4-ethylenedioxythiophene) (PEDOT), polyacetylene (PA), polypyrrole (PPy), polythiophene (PT), polyphenylene sulfide (PPS), poly(p-phenylene vinylene) (PPV), and polyaniline (PANI).

6. The anode for a lithium secondary battery according to claim 1, wherein the water-soluble polymer is electrostatically bonded to the conductive polymer.

7. The anode for a lithium secondary battery according to claim 1, wherein the water-soluble polymer comprises polyacrylic acid (PAA), polyvinyl alcohol (PVA) or a copolymer of polyacrylic acid and polyvinyl alcohol (PAA-PVA copolymer).

8. The anode for a lithium secondary battery according to claim 1, wherein a ratio of the content of the conductive polymer to the content of the water-soluble polymer is 1 to 9 by weight.

9. The anode for a lithium secondary battery according to claim 1, wherein a content of the conductive additive included in the second anode active material layer is 0.01% by weight to 2% by weight based on the total weight of the second anode active material layer.

10. The anode for a lithium secondary battery according to claim 1, wherein the second anode active material layer further comprises a conductive material.

11. The anode for a lithium secondary battery according to claim 10, wherein the conductive material comprises carbon nanotubes.

12. The anode for a lithium secondary battery according to claim 10, wherein a content of the conductive material is 0.05% by weight to 2% by weight based on the total weight of the second anode active material layer.

13. The anode for a lithium secondary battery according to claim 1, wherein a content of the conductive additive in the total weight of the second anode active material layer is lower than the content of the second binder.

14. A secondary battery comprising:
the anode for a secondary battery according to claim 1; and
a cathode disposed to face the anode.
